(19) United States
(12) Patent Application Publication
(10) Pub. No.: US 2025/0007849 A1
(43) Pub. Date: Jan. 2, 2025

(54) ENHANCEMENTS FOR MULTIMODAL SERVICE FLOW COMMUNICATIONS

(71) Applicant: Nokia Technologies Oy, Espoo (FI)

(72) Inventors: Devaki CHANDRAMOULI, Dallas, TX (US); Markus Sakari ISOMÄKI, Espoo (FI); Pilar ANDRÉS MALDONADO, Aalborg (DK); Zexian LI, Espoo (FI)

(21) Appl. No.: 18/700,253

(22) PCT Filed: Oct. 11, 2021
(86) PCT No.: PCT/US2021/054396

§ 371 Date: Apr. 10, 2024

(51) Int. Cl. H04L 47/2441; H04W 36/36

(52) U.S. Cl. CPC H04L 47/2441; H04W 36/362

(57) ABSTRACT

Techniques for enhancing multimodal service flow communications within communication networks are discussed. In an example embodiment, an apparatus is configured to receive one or more connection messages for one or more user devices. The apparatus is further configured to manage one or more data traffic flows associated with the one or more user devices based at least in part on a received service correlation identifier.

### TECHNOLOGICAL FIELD

An example embodiment relates generally to wireless communications and, more particularly, but not exclusively, to enhancing multimodal service flow communications within communication networks. Multimodal service flow communications in this context cover all communications services that use multiple correlated simultaneous data traffic flows between two or more network endpoints. Individual data traffic flows may but do not need to represent different communication modalities.

### BACKGROUND

Next generation or fifth generation (5G) technology was designed to provide high capacity mobile multimedia with high data rates and is intended to be used not only for human interaction, but also for machine type communications in so-called Internet of Things (IoT) networks. Sixth generation (6G) technology further builds off 5G technology to provide high yield increased processing speeds.

### BRIEF SUMMARY

A method, apparatus, and computer program product are disclosed for enhancing multimodal service flow communications. Such enhanced multimodal service flow communications would allow for a more seamless coordination of individual data traffic flows which correspond to a multimodal service flow. Furthermore, enhanced multimodal service flow communications allow for enhanced coordination of the data traffic flows corresponding to a multimodal service flow to be defined for specific services such that synchronization among data traffic flows is customizable and dependent on the particular service and/or preferences. As such, such enhanced multimodal service flow communications may improve communication networks by providing improved coordination amongst data traffic streams belonging to a multimodal service flow and reduce signal latency and expenditure of computational resources by more efficiently managing data traffic streams within a multimodal service flow.

In an example embodiment, a method is provided for receiving one or more connection messages for one or more user devices. In some embodiments the one or more connection messages for the one or more user devices are part of the configuration of multimodal service flow and a respective connection message comprises at least a service correlation identifier. The method may further include managing one or more data traffic flows associated with the one or more user devices based at least in part on the received service correlation identifier.

In some embodiments, the method further includes receiving, one or more assistance parameters corresponding to a particular service correlation identifier. In some embodiments, the one or more assistance parameters comprise at least one or more correlation assistance parameters, and the one or more correlation assistance parameters are indicative of at least one or more of (i) an indication of which data traffic flows from the one or more user devices are correlated with one another, (ii) a priority class indicative of a relative priority ranking between the one or more correlated data traffic flows, (iii) which of the correlated data traffic flows are designated as mandatory, or (iv) which correlated data traffic flows are dependent data traffic flows.

In some embodiments, the method further includes, in an instance of detection of an interruption associated with a mandatory data traffic flow, stopping serving of the one or more correlated data traffic flows.

In some embodiments, the method further includes, in an instance of detection of an interruption associated with a mandatory data traffic flow, updating the relative priority class of the one or more correlated data traffic flows to the lowest relative priority class.

In some embodiments, the method further includes allocating resources for one or more data traffic flows based at least in part on the relative priority ranking between the one or more correlated data traffic flows.

In some embodiments, the method further includes, in an instance in which a handover procedure is required for at least one of the correlated data traffic flows, causing a handover of one or more additional correlated data traffic flows which are dependent on the data traffic flow for which the handover procedure is required.

In some embodiments, the method further includes, mapping one or more quality of service flows associated with the one or more user devices to one or more data radio bearers based at least in part on the received service correlation identifier.

In an example embodiment, an apparatus is provided with means for receiving one or more connection messages for one or more user devices. In some embodiments the one or more connection messages for the one or more user devices are part of the configuration of multimodal service flow and a respective connection message comprises at least a service correlation identifier. The apparatus may further include means for managing one or more data traffic flows associated with the one or more user devices based at least in part on the received service correlation identifier.

In some embodiments, the apparatus further includes means for receiving one or more assistance parameters corresponding to a particular service correlation identifier. In some embodiments, the one or more assistance parameters comprise at least one or more correlation assistance parameters, and the one or more correlation assistance parameters are indicative of at least one or more of (i) an indication of which data traffic flows from the one or more user devices are correlated with one another, (ii) a priority class indicative of a relative priority ranking between the one or more correlated data traffic flows, (iii) which of the correlated data traffic flows are designated as mandatory, or (iv) which correlated data traffic flows are dependent data traffic flows.

In some embodiments, the apparatus further includes means for, in an instance of detection of an interruption associated with a mandatory data traffic flow, stopping serving of the one or more correlated data traffic flows.

In some embodiments, the apparatus further includes means for, in an instance of detection of an interruption associated with a mandatory data traffic flow, updating the relative priority class of the one or more correlated data traffic flows to the lowest relative priority class.

In some embodiments, the apparatus further includes means for allocating resources for one or more data traffic flows based at least in part on the relative priority ranking between the one or more correlated data traffic flows.

In some embodiments, the apparatus further includes means for, in an instance in which a handover procedure is required for at least one of the correlated data traffic flows, causing a handover of one or more additional correlated data traffic flows which are dependent on the data traffic flow for which the handover procedure is required.

In some embodiments, the apparatus further includes means for, mapping one or more quality of service flows associated with the one or more user devices to one or more data radio bearers based at least in part on the received service correlation identifier.

In an example embodiment, an apparatus is provided including processing circuitry and at least one memory including computer program code with the at least one memory and the computer program code configured to, with the processing circuitry, cause the apparatus at least to receive one or more connection messages for one or more user devices. In some embodiments, the one or more connection messages for the one or more user devices are part of the configuration of multimodal service flow and a respective connection message comprises at least a service correlation identifier. The at least one memory and the computer program code are further configured to, with the at least one processor, cause the apparatus at least to manage one or more data traffic flows associated with the one or more user devices based at least in part on the received service correlation identifier.

In some embodiments, the at least one memory and the computer program code are further configured to, with the at least one processor, cause the apparatus at least to receive one or more assistance parameters corresponding to a particular service correlation identifier. In some embodiments, the one or more assistance parameters comprise at least one or more correlation assistance parameters, and the one or more correlation assistance parameters are indicative of at least one or more of (i) an indication of which data traffic flows from the one or more user devices are correlated with one another, (ii) a priority class indicative of a relative priority ranking between the one or more correlated data traffic flows, (iii) which of the correlated data traffic flows are designated as mandatory, or (iv) which correlated data traffic flows are dependent data traffic flows.

In some embodiments, the at least one memory and the computer program code are further configured to, with the at least one processor, cause the apparatus at least to, in an instance of detection of an interruption associated with a mandatory data traffic flow, stop serving the one or more correlated data traffic flows.

In some embodiments, the at least one memory and the computer program code are further configured to, with the at least one processor, cause the apparatus at least to, in an instance of detection of an interruption associated with a mandatory data traffic flow, update the relative priority class of the one or more correlated data traffic flows to the lowest relative priority class.

In some embodiments, the at least one memory and the computer program code are further configured to, with the at least one processor, cause the apparatus at least to, allocate resources for one or more data traffic flows based at least in part on the relative priority ranking between the one or more correlated data traffic flows.

In some embodiments, the at least one memory and the computer program code are further configured to, with the at least one processor, cause the apparatus at least to, in an instance in which a handover procedure is required for at least one of the correlated data traffic flows, cause a handover of one or more additional correlated data traffic flows which are dependent on the data traffic flow for which the handover procedure is required.

In some embodiments, the at least one memory and the computer program code are further configured to, with the at least one processor, cause the apparatus at least to map one or more quality of service flows associated with the one or more user devices to one or more data radio bearers based at least in part on the received service correlation identifier.

In an example embodiment, a computer program product is provided that includes at least one non-transitory computer-readable storage medium having computer executable program code instructions stored therein with the computer executable program code instructions including program code instructions configured, upon execution, to receive one or more connection messages for one or more user devices. In some embodiments, the one or more connection messages for the one or more user devices are part of the configuration of multimodal service flow and a respective connection message comprises at least a service correlation identifier. The computer executable program code instructions further include program code instructions configured, upon execution, to manage one or more data traffic flows associated with the one or more user devices based at least in part on the received service correlation identifier.

In some embodiments, the computer executable program code instructions further include program code instructions configured, upon execution, to receive one or more assistance parameters corresponding to a particular service correlation identifier. In some embodiments, the one or more assistance parameters comprise at least one or more correlation assistance parameters, and the one or more correlation assistance parameters are indicative of at least one or more of (i) an indication of which data traffic flows from the one or more user devices are correlated with one another, (ii) a priority class indicative of a relative priority ranking between the one or more correlated data traffic flows, (iii) which of the correlated data traffic flows are designated as mandatory, or (iv) which correlated data traffic flows are dependent data traffic flows.

In some embodiments, the computer executable program code instructions further include program code instructions configured, upon execution, to, in an instance of detection of an interruption associated with a mandatory data traffic flow, stop serving the one or more correlated data traffic flows.

In some embodiments, the computer executable program code instructions further include program code instructions configured, upon execution, to, in an instance of detection of an interruption associated with a mandatory data traffic flow, update the relative priority class of the one or more correlated data traffic flows to the lowest relative priority class.

In some embodiments, the computer executable program code instructions further include program code instructions configured, upon execution, to, allocate resources for one or more data traffic flows based at least in part on the relative priority ranking between the one or more correlated data traffic flows.

In some embodiments, the computer executable program code instructions further include program code instructions configured, upon execution, to, in an instance in which a handover procedure is required for at least one of the correlated data traffic flows, cause a handover of one or more additional correlated data traffic flows which are dependent on the data traffic flow for which the handover procedure is required.

In some embodiments, the computer executable program code instructions further include program code instructions configured, upon execution, to, map one or more quality of service flows associated with the one or more user devices to one or more data radio bearers based at least in part on the received service correlation identifier.

In an example embodiment, a method is provided for requesting a service correlation identifier for the one or more user devices associated with one or more connection messages. In some embodiments, the one or more connection messages for the one or more user devices are part of a configuration of multimodal service flow, the request for the service correlation identifier includes one or more user device addresses for the one or more user devices, and the service correlation identifier correlates individual connection sessions of the one or more user devices with one another. The method may further include providing a service correlation identifier for the one or more user devices to one or more network entity functions.

In some embodiments, the method further includes determining one or more assistance parameters for each data traffic flow corresponding to the service correlation identifier. In some embodiments, the method further includes providing the one or more assistance parameters to the one or more network entity functions.

In some embodiments, the one or more assistance parameters include at least one or more correlation assistance parameters, and the one or more correlation assistance parameters are indicative of at least one or more of (i) an indication of which data traffic flows from the one or more user devices are correlated with one another, (ii) a priority class indicative of a relative priority ranking between the one or more correlated data traffic flows, (iii) which of the correlated data traffic flows are designated as mandatory, or (iv) which correlated data traffic flows are dependent data traffic flows.

In an example embodiment, an apparatus is provided with means for requesting a service correlation identifier for the one or more user devices associated with one or more connection messages. In some embodiments, the one or more connection messages for the one or more user devices are part of a configuration of multimodal service flow, the request for the service correlation identifier includes one or more user device addresses for the one or more user devices, and the service correlation identifier correlates individual connection sessions of the one or more user devices with one another. The apparatus may further include means for providing a service correlation identifier for the one or more user devices to one or more network entity functions.

In some embodiments, the apparatus further includes means for determining one or more assistance parameters for each data traffic flow corresponding to the service correlation identifier. In some embodiments, the apparatus further includes means for providing the one or more assistance parameters to the one or more network entity functions.

In some embodiments, the one or more assistance parameters include at least one or more correlation assistance parameters, and the one or more correlation assistance parameters are indicative of at least one or more of (i) an indication of which data traffic flows from the one or more user devices are correlated with one another, (ii) a priority class indicative of a relative priority ranking between the one or more correlated data traffic flows, (iii) which of the correlated data traffic flows are designated as mandatory, or (iv) which correlated data traffic flows are dependent data traffic flows.

In an example embodiment, an apparatus is provided including processing circuitry and at least one memory including computer program code with the at least one memory and the computer program code configured to, with the processing circuitry, cause the apparatus at least to request a service correlation identifier for the one or more user devices associated with one or more connection messages. In some embodiments, the one or more connection messages for the one or more user devices are part of a configuration of multimodal service flow, the request for the service correlation identifier includes one or more user device addresses for the one or more user devices, and the service correlation identifier correlates individual connection sessions of the one or more user devices with one another. The at least one memory and the computer program code may further be configured to, with the at least one processor, cause the apparatus at least to provide a service correlation identifier for the one or more user devices to one or more network entity functions.

In some embodiments, the at least one memory and the computer program code are further configured to, with the at least one processor, cause the apparatus at least to determine one or more assistance parameters for each data traffic flow corresponding to the service correlation identifier. In some embodiments, the at least one memory and the computer program code are further configured to, with the at least one processor, cause the apparatus at least to provide the one or more assistance parameters to the one or more network entity functions.

In some embodiments, the one or more assistance parameters include at least one or more correlation assistance parameters, and the one or more correlation assistance parameters are indicative of at least one or more of (i) an indication of which data traffic flows from the one or more user devices are correlated with one another, (ii) a priority class indicative of a relative priority ranking between the one or more correlated data traffic flows, (iii) which of the correlated data traffic flows are designated as mandatory, or (iv) which correlated data traffic flows are dependent data traffic flows.

In an example embodiment, a computer program product is provided that includes at least one non-transitory computer-readable storage medium having computer executable program code instructions stored therein with the computer executable program code instructions including program code instructions configured, upon execution, to request a service correlation identifier for the one or more user devices associated with one or more connection messages. In some embodiments, the one or more connection messages for the one or more user devices are part of a configuration of multimodal service flow, the request for the service correlation identifier includes one or more user device addresses for the one or more user devices, and the service correlation identifier correlates individual connection sessions of the one or more user devices with one another. The computer executable program code instructions may further include program code instructions configured, upon execution, to provide a service correlation identifier for the one or more user devices to one or more network entity functions.

In some embodiments, the computer executable program code instructions further include program code instructions configured, upon execution, to determine one or more assistance parameters for each data traffic flow corresponding to the service correlation identifier. In some embodiments, the computer executable program code instructions further include program code instructions configured, upon execution, to provide the one or more assistance parameters to the one or more network entity functions.

In some embodiments, the one or more assistance parameters include at least one or more correlation assistance parameters, and the one or more correlation assistance parameters are indicative of at least one or more of (i) an indication of which data traffic flows from the one or more user devices are correlated with one another, (ii) a priority class indicative of a relative priority ranking between the one or more correlated data traffic flows, (iii) which of the correlated data traffic flows are designated as mandatory, or (iv) which correlated data traffic flows are dependent data traffic flows.

In an example embodiment, a method is provided for receiving one or more connection messages for one or more user devices. In some embodiments, the one or more connection messages for the one or more user devices are part of a configuration of multimodal service flow, and (ii) a respective connection message comprises at least a service correlation identifier. The method may further include mapping the one or more user devices' connection sessions and associated quality of service flows with the service correlation identifier. The method may further include providing the one or more connection messages and the service correlation identifier for the one or more user devices to an access network node.

In some embodiments, the method may further include determining whether the service correlation identifier for the respective connection message from one or more user devices are aligned. In some embodiments, the method further includes, in an instance the service correlation identifier for each connection message from one or more user devices are aligned, providing the one or more connection messages to the access network node.

In some embodiments, the method may further include determining the service correlation identifier for requesting a service correlation identifier and one or more assistance parameters for the one or more user devices. In some embodiments, the method further includes providing the service correlation identifier and one or more assistance parameters to the one or more user devices.

In some embodiments, the method further includes determining a service correlation identifier configuration, wherein the service correlation identifier configuration comprises at least (i) the service correlation identifier and (ii) the one or more assistance parameters.

In some embodiments, the service correlation identifier is used to track user device events for the one or more user devices. In some embodiments, the service correlation identifier is provided to the access network node for a respective quality of service flow.

In an example embodiment, an apparatus is provided with means for receiving one or more connection messages for one or more user devices. In some embodiments, the one or more connection messages for the one or more user devices are part of a configuration of compound service flow, and (ii) a respective connection message comprises at least a service correlation identifier. The apparatus may further include means for mapping the one or more user devices' connection sessions and associated quality of service flows with the service correlation identifier. The apparatus may further include means for providing the one or more connection messages and the service correlation identifier for the one or more user devices to an access network node.

In some embodiments, the apparatus may further include means for determining the service correlation identifier for the respective connection message from one or more user devices are aligned. In some embodiments, the apparatus may further include means for, in an instance the service correlation identifier for each connection message from one or more user devices are aligned, providing the one or more connection messages to the access network node.

In some embodiments, the apparatus may further include means for determining whether the service correlation identifier for requesting a service correlation identifier and one or more assistance parameters for the one or more user devices. In some embodiments, the apparatus may further include means for providing the service correlation identifier and one or more assistance parameters to the one or more user devices.

In some embodiments, the apparatus may further include means for determining a service correlation identifier configuration, wherein the service correlation identifier configuration comprises at least (i) the service correlation identifier and (ii) the one or more assistance parameters.

In some embodiments, the service correlation identifier is used to track user device events for the one or more user devices. In some embodiments, the service correlation identifier is provided to the access network node for a respective quality of service flow.

In an example embodiment, an apparatus is provided including processing circuitry and at least one memory including computer program code with the at least one memory and the computer program code configured to, with the processing circuitry, cause the apparatus at least to receive one or more connection messages for one or more user devices. In some embodiments, the one or more connection messages for the one or more user devices are part of a configuration of compound service flow and a respective connection message comprises at least a service correlation identifier. The at least one memory and the computer program code are further configured to, with the at least one processor, cause the apparatus at least to map the one or more user devices' connection sessions and associated quality of service flows with the service correlation identifier. The at least one memory and the computer program code are further configured to, with the at least one processor, cause the apparatus at least to provide the one or more connection messages and the service correlation identifier for the one or more user devices to an access network node.

In some embodiments, the at least one memory and the computer program code are further configured to, with the at least one processor, cause the apparatus at least to determine whether the service correlation identifier for the respective connection message from one or more user devices are aligned. In some embodiments, the at least one memory and the computer program code are further configured to, with the at least one processor, cause the apparatus at least to, in an instance the service correlation identifier for each connection message from one or more user devices are aligned, provide the one or more connection messages to the access network node.

In some embodiments, the at least one memory and the computer program code are further configured to, with the at least one processor, cause the apparatus at least to request a service correlation identifier and one or more assistance parameters for the one or more user devices. In some embodiments, the at least one memory and the computer program code are further configured to, with the at least one processor, cause the apparatus at least to provide the service correlation identifier and one or more assistance parameters to the one or more user devices.

In some embodiments, the at least one memory and the computer program code are further configured to, with the at least one processor, cause the apparatus at least to determine a service correlation identifier configuration, wherein the service correlation identifier configuration comprises at least (i) the service correlation identifier and (ii) the one or more assistance parameters.

In some embodiments, the service correlation identifier is used to track user device events for the one or more user devices. In some embodiments, the service correlation identifier is provided to the access network node for a respective quality of service flow.

In an example embodiment, a computer program product is provided that includes at least one non-transitory computer-readable storage medium having computer executable program code instructions stored therein with the computer executable program code instructions including program code instructions configured, upon execution, to receive one or more connection messages for one or more user devices. In some embodiments, the one or more connection messages for the one or more user devices are part of a configuration of compound service flow and a respective connection message comprises at least a service correlation identifier. The computer executable program code instructions may further include program code instructions configured, upon execution, to map the one or more user devices' connection sessions and associated quality of service flows with the service correlation identifier. The computer executable program code instructions further include program code instructions configured, upon execution, to cause the apparatus at least to provide the one or more connection messages and the service correlation identifier for the one or more user devices to an access network node.

In some embodiments, the computer executable program code instructions further include program code instructions configured, upon execution, to determine whether the service correlation identifier for the respective connection message from one or more user devices are aligned. In some embodiments, the computer executable program code instructions further include program code instructions configured, upon execution, to in an instance the service correlation identifier for each connection message from one or more user devices are aligned, provide the one or more connection messages to the access network node.

In some embodiments, the computer executable program code instructions further include program code instructions configured, upon execution, to request a service correlation identifier and one or more assistance parameters for the one or more user devices In some embodiments, the computer executable program code instructions further include program code instructions configured, upon execution, to provide the service correlation identifier and one or more assistance parameters to the one or more user devices.

In some embodiments, the computer executable program code instructions further include program code instructions configured, upon execution, to determine a service correlation identifier configuration, wherein the service correlation identifier configuration comprises at least (i) the service correlation identifier and (ii) the one or more assistance parameters.

In some embodiments, the service correlation identifier is used to track user device events for the one or more user devices. In some embodiments, the service correlation identifier is provided to the access network node for a respective quality of service flow.

In an example embodiment, a method is provided for providing a connection message to a network function. In some embodiments, the connection message is part of the configuration of a multimodal service flow, the connection message comprises one or more assistance parameters, and the one or more assistance parameters comprise at least a service correlation identifier.

In some embodiments, at least one of the (i) service correlation identifier or (ii) the one or more assistance parameters are preconfigured in an associated memory of the apparatus.

In some embodiments, the method further includes receiving, from a network entity, at least one of (i) the service correlation identifier or (ii) the one or more assistance parameters. In some embodiments, the method further includes storing the service correlation identifier or the one or more assistance parameters in an associated memory.

In some embodiments, the connection message comprises a packet data unit procedure message.

In an example embodiment, an apparatus is provided with means for providing a connection message to a network function. In some embodiments, the connection message is part of the configuration of a multimodal service flow, the connection message comprises one or more assistance parameters, and the one or more assistance parameters comprise at least a service correlation identifier.

In some embodiments, at least one of the (i) service correlation identifier or (ii) the one or more assistance parameters are preconfigured in an associated memory of the apparatus.

In some embodiments, the apparatus further includes means for receiving, from a network entity, at least one of (i) the service correlation identifier or (ii) the one or more assistance parameters. In some embodiments, the apparatus further includes means for storing the service correlation identifier or the one or more assistance parameters in an associated memory.

In some embodiments, the connection message comprises a packet data unit procedure message.

In an example embodiment, an apparatus is provided including processing circuitry and at least one memory including computer program code with the at least one memory and the computer program code configured to, with the processing circuitry, cause the apparatus at least to provide a connection message to a network function. In some embodiments, the connection message is part of the configuration of a multimodal service flow, the connection message comprises one or more assistance parameters, and the one or more assistance parameters comprise at least a service correlation identifier.

In some embodiments, at least one of the (i) service correlation identifier or (ii) the one or more assistance parameters are preconfigured in an associated memory of the apparatus.

In some embodiments, the at least one memory and the computer program code are further configured to, with the at least one processor, cause the apparatus at least to receive, from a network entity, at least one of (i) the service correlation identifier or (ii) the one or more assistance parameters. In some embodiments, the at least one memory and the computer program code are further configured to, with the at least one processor, cause the apparatus at least to store the service correlation identifier or the one or more assistance parameters in an associated memory.

In some embodiments, the connection message comprises a packet data unit procedure message.

In an example embodiment, a computer program product is provided that includes at least one non-transitory computer-readable storage medium having computer executable program code instructions stored therein with the computer executable program code instructions including program code instructions configured, upon execution, to provide a connection message to a network function. In some embodiments, the connection message is part of the configuration of a multimodal service flow, the connection message comprises one or more assistance parameters, and the one or more assistance parameters comprise at least a service correlation identifier.

In some embodiments, at least one of the (i) service correlation identifier or (ii) the one or more assistance parameters are preconfigured in an associated memory of the apparatus.

In some embodiments, the computer executable program code instructions further include program code instructions configured, upon execution, to receive, from a network entity, at least one of (i) the service correlation identifier or (ii) the one or more assistance parameters. In some embodiments, the computer executable program code instructions further include program code instructions configured, upon execution, to store the service correlation identifier or the one or more assistance parameters in an associated memory.

In some embodiments, the connection message comprises a packet data unit procedure message.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 depicts a multimodal service flow communication network in an illustrative embodiment;

FIG. 2 shows a communication system in an illustrative embodiment;

FIG. 3 is a block diagram of an apparatus that may be specifically configured in accordance with an example embodiment of the present disclosure;

FIG. 4 shows a message flow for message exchanges within a multimodal service flow communication network using a service correlation identifier in an illustrative embodiment;

FIG. 5 shows a message flow for message exchanges to assign a service correlation identifier within a multimodal service flow communication network in an illustrative embodiment;

FIG. 6 illustrates a flow diagram for managing data traffic flow corresponding to a multimodal service flow associated with one or more user devices in an illustrative embodiment;

FIG. 7 illustrates a flow diagram for providing a connection message to a network function in an illustrative embodiment;

FIG. 8 illustrates a flow diagram requesting a service correlation identifier in an illustrative embodiment; and

FIG. 9 illustrates a flow diagram for mapping one or more user device connection sessions and associated quality of service flows with the service correlation identifier in an illustrative embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

The evolution of new communication technologies such as 5G and 6G have improved upon existing technologies such as second generation (2G) technologies, third generation (3G) technologies, fourth generation (4G) technologies and long term evolution (LTE) technologies and has thus resulted in improved network connectivity. Such improvements have allowed for communication systems to support compound service flow communication services. A compound service flow may refer to any service flow which includes two or more data traffic flows which are related to one another. Conventionally, compound service flow communications have been limited to audio and video communications. However, with the introduction of 5G, other information types within compound service flow communications are realized. For example, modalities of a compound service flow communication service may include video, audio, information perceived by sensors (e.g., brightness detection, temperature, humidity, equipment status, locality, etc.), and/or haptic data.

To support and effectively provide multimodal service flow communication services, the communication network may need to address service requirements of different data traffic streams with coordinated quality of service (QOS) selection, packet processing, sufficient latency and reliability, and time synchronization of parallel information from the different data traffic streams in order to provide a positive user experience. Furthermore, different data traffic streams representing different modalities may be processed by different user devices (UEs). For example, camera and displays for video streams, microphones, speakers, and/or headphones for audio streams, and equipment used for haptic sensing and feedback may all be integrated in a single UE or may distributed across multiple UEs. As such, this requires a degree of coordination by the communication network such that the receiving applications, devices, and/or UEs may receive the data streams in a synchronized manner.

The coordination needs for a multimodal service flow communication service may be dependent upon the specific multimodal service flow service. For example, some multimodal service flow services may prioritize treatment of all data streams within the multimodal service flow service in a similar and synchronized fashion when faced with a mobility event, such as congestion and/or disruption within an access network (AN) and/or core network (CN). As another example, some multimodal service flow services may prioritize maintaining certain data streams over other data streams during such mobility events.

The data streams of the multimodal service flow service may also be mapped to internet protocol (IP) transport traffic flows and/or 5G system (5GS) QoS flows in different ways. For example, a 5GS may carry multimodal service flow services involving a virtual reality (VR) device which can receive video and audio and a sensor which can detect locality and angle together, on a single traffic flow or a different traffic flow.

If compound service flow services are transmitted on a single traffic flow, these different modality packets can be transmitted in different periodic times, but they may have different QoS requirements. To support the coordination processing, it would be beneficial for the 5GS to identify the different data packets and implement the corresponding QoS rules. In the event a data packet (e.g., video data packet and/or video frame) is lost due to limited network resources, retransmission may occur in the application layer and the audio data packet should be held or dropped to allow the compound service flow service packets to reach the end processor at the same time.

When multiple UEs detect different information (e.g., multiple factory robots), the 5GS should identify the multimodal service flows from the different UEs and coordinate the data traffic transfer. Such coordination methods may include holding on to or dropping the data packet from one UE such that the time difference for an end processor receiving multimodality services is within a particular period of time. The latency for some multimodal service flow services are critical. For example, for haptic feedback the communication delay for haptic modality should be reasonably less than 5 milliseconds.

Therefore, it may be beneficial to provide assistance parameters to enhance multimodality communications. These assistance parameters may be provided to one or more UEs, one or more functions within the CN, and to one or more access network (AN) nodes within an AN, such as a radio access network (RAN). Advantageously, the assistance parameters may indicate the UE sessions as well as data radio bearers (DRBs) that are part of the same multimodal service flows. As such, a AN node may handle the corresponding service flows in a correlated manner, even during interruption events such as network congestion events. Furthermore, in some embodiments, the assistance parameters may include correlation assistance information pertaining to individual QoS service flows. As such, an AN node may handle QoS flows for each respective UE in a correlated manner.

In order to better coordinate the individual data traffic flows in the network the following information about each data traffic flows may be used: (i) Service correlation identifier with the identical identifier indicating that the data traffic flows are correlated in general. (ii) Priority class indicates the relative priority ranking among the correlated data traffic flows, even if the flows had the same absolute priority. This allows finer granularity prioritization among the correlated flows in situations where they all cannot be served ideally. (iii) Mandatory indicates that the data traffic flow has the highest relative priority class and is designated as mandatory among the set of correlated data traffic flows. Mandatory means that if the network is not able to serve this data traffic flow according to its requirements, the whole multimodal service consisting of multiple correlated data traffic flows is deemed to fail and serving the other data traffic flows is no longer useful. (iv) Dependent indicates that specific dependent treatment is requested for the correlated data traffic flows, with one example being that the radio handovers affecting them should be conducted in a coordinated way.

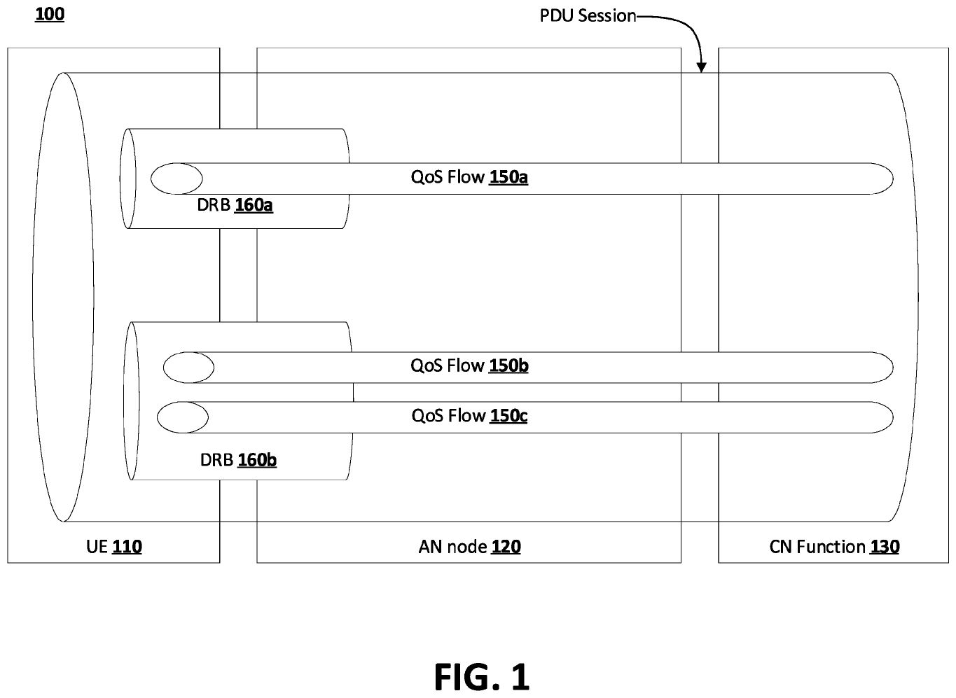

FIG. 1 illustrates an example communication network 100 within which certain illustrative embodiments are to be implemented. However, it is to be appreciated that embodiments are not limited to the network configurations illustrated herein or otherwise described below. It is to be understood that the elements shown in communication system 100 are intended to represent an example embodiment of a multimodality communication services using a single UE, AN node, and CN function. However, any number of UEs, AN nodes, and CN functions may be contemplated. Furthermore, the term CN function refers generically to a CN function such that any CN function may be contemplated. Furthermore, although the communication network 100 is described with reference to 5G communication technology, other communication technologies such as 2G. 3G, 4G, LTE, and 6G to name but a few, may be contemplated.

As depicted in FIG. 1, a UE 110 may have an established packet data unit (PDU) session with a CN function 130 via a AN node 120. Within the PDU session, the UE 110 has one or more DRBs 160a-b with the AN node 120 as established by the AN node 120. The one or more DRBs 160a-b may be established during the PDU session establishment. Individual QoS flows 150a-c may be mapped to a particular DRB (e.g., using an access stratum (AS) filter) and data packets may be mapped to an appropriate QoS flow (e.g., using a non-access stratum (NAS) filter). The particular QoS flow 150a-c may define requirements regarding the PDU connection.

In accordance with an example embodiment discussed herein, for a data traffic flow from one or more UEs, a service correlation identifier may be assigned to a particular PDU session such that all QoS flows 150a-c and/or DRBs 160a-b are mapped to the service correlation identifier. The service correlation identifier may correlate individual connection sessions of the one or more user devices with one another. Additionally or alternatively, a service correlation identifier may be assigned to a particular QoS flow such that individual QoS flows 150a-c within the same PDU session may be associated with different service correlation identifiers.

By way of example, the communication system 200 may be deployed within a radio access architecture. However, the system may be deployed in other applications including within other communication networks including, for example, long term evolution advanced (LTE Advanced, LTE-A), a universal mobile telecommunications system (UMTS) radio access network (UTRAN or E-UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof. Any access network eligible to access the core network may be employed. In order to access a 5G core network, an access network such as an Un-trusted Non 3GPP access terminated at a Non-3GPP interworking function (N3IWF), a trusted Non-3GPP access terminated at a trusted non-3GPP gateway function (TNGF) or a Wireline access terminated at a wireless access gateway function (W-AGF) may be used instead of the NG RAN/gNB. Moreover, although described herein in conjunction with a 5G core network, the method, apparatus and computer program product of certain example embodiments may be employed in conjunction with other technologies, such as a 6G network or the like.

By way of example, the communication system 200 may be deployed within a radio access architecture. However, the system may be deployed in other applications including within other communication networks including, for example, long term evolution advanced (LTE Advanced, LTE-A), a universal mobile telecommunications system (UMTS) radio access network (UTRAN or E-UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof. Any access network eligible to access the 5G core network such as an Un-trusted Non 3GPP access terminated at a Non-3GPP interworking function (N3IWF), a trusted Non-3GPP access terminated at a trusted non-3GPP gateway function (TNGF) or a Wireline access terminated at a wireless access gateway function (W-AGF) may be used instead of the NG RAN/gNB. Moreover, although described herein in conjunction with a 5G core network, the method, apparatus and computer program product of certain example embodiments may be employed in conjunction with other technologies, such as a 6G network or the like.

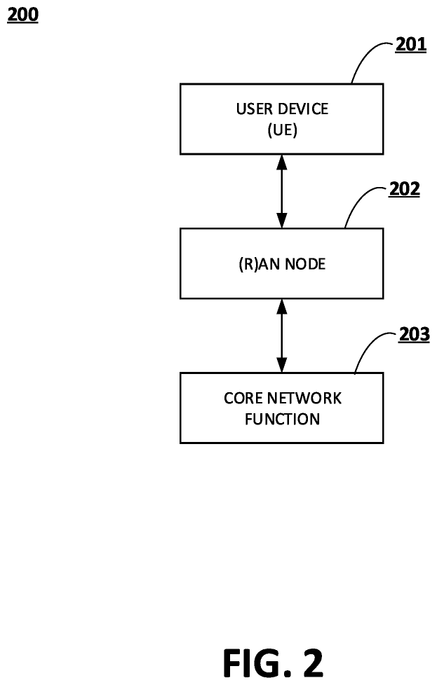

In the radio access architecture of FIG. 2, user device 201 is configured to be in a wireless connection on one or more communication channels in a cell with a radio access network (RAN) node, such as a gNB. The physical link from a user device 201 to a gNB is called the uplink or reverse link and the physical link from the gNB to the UE is called the downlink or forward link. It should be appreciated that the gNBs, or their functionalities may be implemented by using any node, host, server or access point (AP), etc. entity suitable for such a usage.

A communications system typically comprises more than one gNB, in which case the gNBs may also be configured to communicate with one another over links, wired or wireless, designed for the purpose. These links may be used for signaling purposes. The gNB is a computing device configured to control the radio resources of the communication system to which the gNB is coupled. The gNB may also be referred to as a base station, an access point or any other type of interfacing device including a relay station capable of operating in a wireless environment. The gNB includes or is coupled to transceiver(s). From the transceivers of the gNB, a connection is provided to an antenna unit that establishes bi-directional radio links to UEs. As such, the transceivers of the gNB and the transceivers of the UEs may include transmitters and receivers configured to communicate via a channel. Although reference is made to a gNB herein, although this is by way of example, but not of limitation, as other types of AN nodes may alternatively be employed.

Accordingly, as shown, communication system 200 comprises UE 201 that communicates, such as via an air interface, with a AN node 202. In some embodiments, the AN node 202 is a RAN node. The UE 201 may be a mobile station, and such a mobile station may comprise, by way of example, a mobile telephone, a computer, or any other type of communication device. In an LTE-V2X implementation, one or more UEs may be deployed in a given vehicle. The term “user device” or “user equipment” as used herein is therefore intended to be construed broadly, so as to encompass a variety of different types of mobile stations, subscriber stations or, more generally, communication devices, including examples such as a combination of a data card inserted in a laptop or other equipment (e.g., a vehicle). The user device 201 may also refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a UE may also be a nearly exclusive uplink only device, of which an example is a camera or video camera loading images or video clips to a network. A UE may also be a device having the capability to operate in an IoT network, which is a scenario in which objects are provided with the ability to transfer data over a network without requiring human-to-human or human-to-computer interaction. The user device (or in some embodiments a layer 3 relay node) is configured to perform one or more user device functionalities. The user device may also be called a subscriber unit, mobile station, remote terminal, access terminal, user terminal or user equipment just to mention but a few names or apparatuses.

In one embodiment, UE 201 is comprised of a Universal Integrated Circuit Card (UICC) and Mobile Equipment (ME). The UICC is the user-dependent part of the UE and contains at least one Universal Subscriber Identity Module (USIM) and appropriate application software. The USIM securely stores the International Mobile Subscriber Identity (IMSI) number and its related key, which are used to identify and authenticate subscribers to access networks. The ME is the user-independent part of the UE and contains terminal equipment (TE) functions and various mobile termination (MT) functions.

The AN node 202 is illustratively part of a AN of the communication system 200. In a 5GS network, the AN node is typically implemented by an gNB. Such an access network may comprise, for example, a plurality of base stations which may include one or more gNBs (which may also be split in a centralized unit (CU) and a distributed unit (DU) part) and/or other AN node types, such as evolved node Bs (cNBs), node Bs, base stations (BTS) and/or non-3GPP interworking function (N3IWF), or any other types of access nodes such as WLAN access points, as well as one or more associated radio network control functions. The base stations and radio network control functions may be logically separate entities, but in a given embodiment may be implemented in the same physical network element, such as, for example, a base station router or femto cellular access point. As will be appreciated by one of skill in the art, any variety of AN nodes and/or access nodes may also implement similar operations, functions, etc.

In some example embodiments, the AN node 202 is operatively coupled to a core network function 203, such as via an NG interface. The network function 203 may include an access and mobility management function (AMF), session management function (SMF), or any of core network function. A core network function may be an element of the core network (CN) part of the communication network 200 that is responsible for one or more associated operations. The core network function may serve as a NAS termination point for a NAS layer security. Each NAS termination point may be uniquely identified using a NAS temporary identifier.

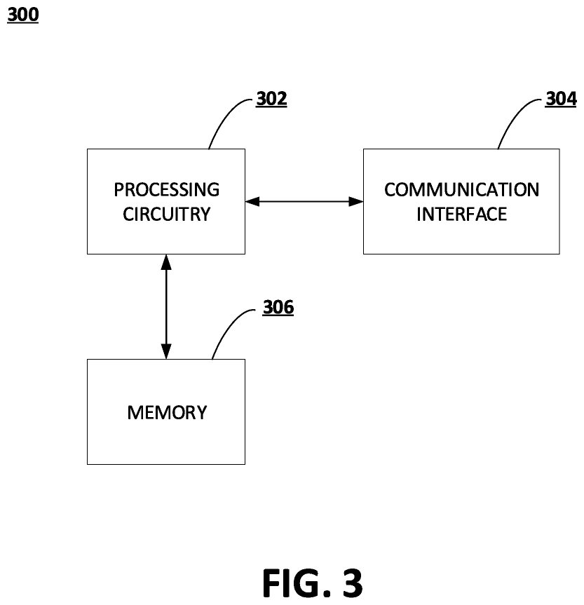

One example of an apparatus 300 that may be configured to function as or may be embodied by a network entity, such as a UE, AN node, AMF, SMF and/or NF-X, is depicted in FIG. 3. As shown in FIG. 3, the apparatus 300 includes, is associated with or is in communication with processing circuitry 302, a memory 306 and a communication interface 304. The processing circuitry 302 may be in communication with the memory device via a bus for passing information among components of the apparatus 300. The memory device 306 may be non-transitory and may include, for example, one or more volatile and/or non-volatile memories. In other words, for example, the memory device 306 may be an electronic storage device (e.g., a computer readable storage medium) comprising gates configured to store data (e.g., bits) that may be retrievable by a machine (e.g., a computing device like the processing circuitry). The memory device 306 may be configured to store information, data, content, applications, instructions, or the like for enabling the apparatus to carry out various functions in accordance with an example embodiment of the present disclosure. For example, the memory device 306 could be configured to buffer input data for processing by the processing circuitry 302. Additionally or alternatively, the memory device 306 could be configured to store instructions for execution by the processing circuitry 302.

The apparatus 300 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processing circuitry 302 may be embodied in a number of different ways. For example, the processing circuitry 302 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 302 may be configured to execute instructions stored in the memory device 306 or otherwise accessible to the processing circuitry 302. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry 302 is embodied as an executor of instructions, the instructions may specifically configure the processor to perform the algorithms and/or operations described herein when the instructions are executed. However, in some cases, the processing circuitry 302 may be a processor of a specific device (e.g., an image or video processing system) configured to employ an embodiment of the present invention by further configuration of the processing circuitry by instructions for performing the algorithms and/or operations described herein. The processing circuitry 302 may include, among other things, a clock, an arithmetic logic unit (ALU) and logic gates configured to support operation of the processing circuitry.

The communication interface 304 may be any means such as a device or circuitry embodied in either hardware or a combination of hardware and software that is configured to receive and/or transmit data, including media content in the form of video or image files, one or more audio tracks or the like. In this regard, the communication interface 304 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

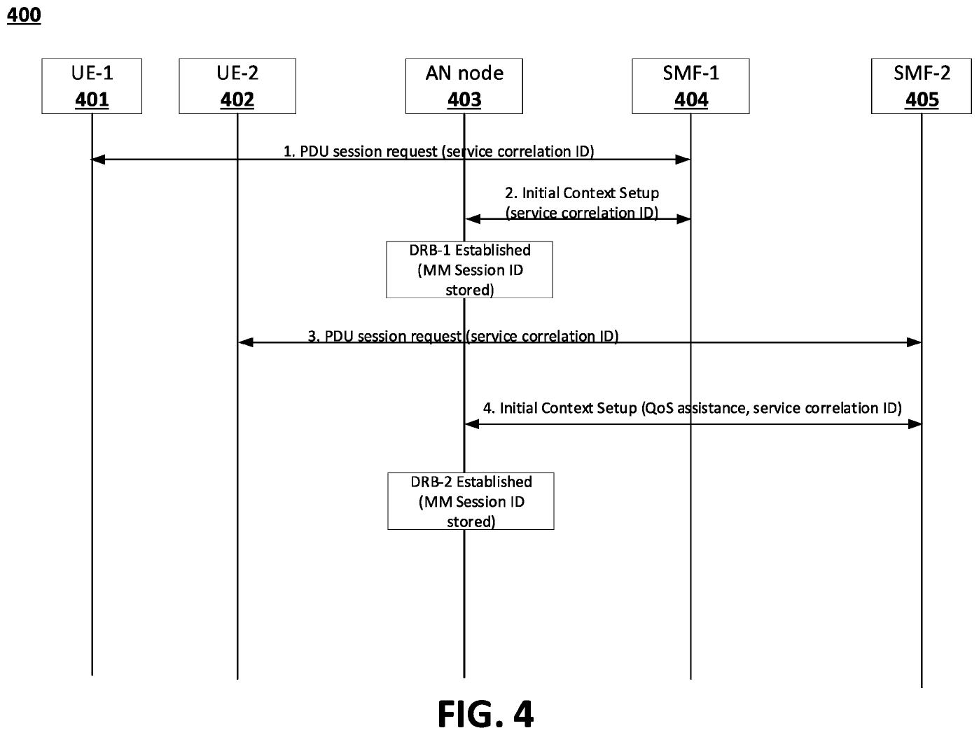

FIG. 4 illustrates messages exchanged between UEs, an AN node, and SMFs for establishment of PDU sessions with the UEs which correspond to multimodal communication services. As will be discussed herein, two UE's and two SMF's are discussed. However, it should be appreciated that any number of UE's and corresponding CN functions, such as an SMF, may also be contemplated.

In operation 1 of FIG. 4, UE-1 401 may provide a connection request message, such as a PDU session request or PDU session modification to an SMF-1 404 via AN node 403. The connection request may include a service correlation identifier (e.g., session ID). In some embodiments, the UE-1 401 is aware that the connection request is associated with a multimodal service flow session request. In some embodiments, the UE-1 401 may provide the service correlation identifier to SMF-1 404. In some embodiments, the service correlation identifier is preconfigured in the UE-1 401. One or more other UEs corresponding to the same multimodal service may be preconfigured with the same service correlation identifier such that each UE of the multimodal service may provide the same service correlation identifier to the CN and/or AN node 403 during a connection procedure, such as a PDU establishment procedure and/or PDU modification procedure.

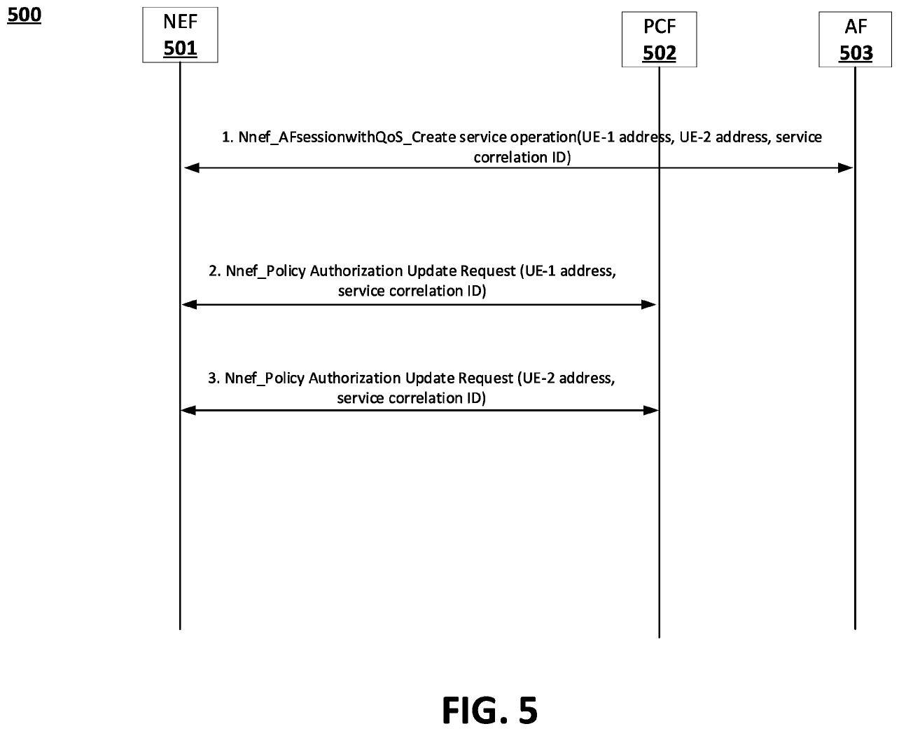

In some embodiments, the application function (AF) 501 may alternatively request a service correlation identifier on behalf of UE-1 401 and UE-2 402, which have a PDU session corresponding to the same multimodal service flow. In some embodiments, the AF 501 may request the service correlation identifier on behalf of UE-1 401 and UE-2 402 during an Nnef_AFsessionwithQoS_create operation as will be discussed in further detail with respect to FIG. 5. In some embodiments, the connection request message may include a flag or any other suitable indication value indicative that the connection request message is part of a configuration of multimodal service flow but has not yet been assigned a service correlation identifier.

In operation 2, the SMF-1 404 may perform an initial context setup with the AN node 403. The SMF-1 404 may provide the AN node 403 with the service correlation identifier as received from the UE-1 401 during the initial context setup. In some embodiments, the initial context setup may also include one or more assistance parameters.

In some embodiments, the one or more assistance parameters are preconfigured in the UE-1 401. The one or more assistance parameters may be received by SMF-1 404 from UE-1 401 during the PDU session request. The SMF-1 may then provide the one or more received assistance parameters to AN node 403 during the initial context setup.

In some embodiments, the one or more assistance parameters may be determined by AF 501. In some embodiments, AF 501 may determine the one or more assistance parameters during the Nnef_AFsessionwithQoS_create operation as will be discussed in further detail with respect to FIG. 5. In this case, the SMF-1 404 may map the PDU sessions for UE-1 401 and UE-2 402 and the QoS flows with the multimodal service flow session as configured by the AF 501. Once the PDU sessions and QoS flows are mapped with the multimodal service flow session, the SMF-1 404 may then extract the multimodal service flow configuration (e.g., at least the service correlation identifier and the one or more assistance parameters) and forward the multimodal service flow configuration to the AN node 403.

In some embodiments, SMF-1 404 checks that assistance parameters for UE-1 401 are aligned with the assistance parameters for other UEs corresponding to the same multimodality session, e.g., UE-2 402 prior to providing the assistance parameters to the AN node 403. In the instance the assistance parameters for UE-1 401 and UE-2 402 match, the SMF-1 404 may forward the assistance parameters to the AN node 403.

Once the AN node 403 receives the multimodal service flow configuration from SMF-1 404, AN node 403 may establish one or more DRBs with UE-1 401. The AN node 403 may also store the service correlation identifier and/or one or more assistance parameters in an associated memory.

In operation 3, UE-2 402 may provide a connection request message, such as a PDU session request to an SMF-2 405 via AN node 403. The connection request may include a service correlation identifier. In some embodiments, the UE-2 402 is aware that the connection request is associated with a multimodal service flow request. In some embodiments, the UE-2 402 may provide the service correlation identifier to SMF-2 405. In some embodiments, the service correlation identifier is preconfigured in the UE-2 402. One or more other UEs corresponding to the same multimodal service may be preconfigured with the same service correlation identifier such that each UE of the multimodal service may provide the same service correlation identifier to the CN and/or AN node 403 during a connection procedure, such as a PDU establishment procedure and/or PDU modification procedure.

In some embodiments, the application function (AF) 501 may alternatively request a service correlation identifier on behalf of UE-1 401 and UE-2 402, which have a PDU session corresponding to the same multimodal service. In some embodiments, the AF 501 may request the service correlation identifier on behalf of UE-1 401 and UE-2 402 during an Nnef_AFsessionwithQoS_create operation as will be discussed in further detail with respect to FIG. 5. In some embodiments, the connection request message may include a flag or any other suitable indication value indicative that the connection request message is part of a configuration of multimodal service flow but has not yet been assigned a service correlation identifier.

In operation 4, the SMF-2 405 may perform an initial context setup with the AN node 403. The SMF-2 405 may provide the AN node 403 with the service correlation identifier as received from the UE-2 402 during the initial context setup. In some embodiments, the initial context setup may also include one or more assistance parameters.

In some embodiments, the one or more assistance parameters are preconfigured in the UE-2 402. The one or more assistance parameters may be received by SMF-2 405 from UE-2 402 during the PDU session request. The SMF-2 may then provide the one or more received assistance parameters to AN node 403 during the initial context setup.

In some embodiments, the one or more assistance parameters may be determined by AF 501. In some embodiments, AF 501 may determine the one or more assistance parameters during the Nnef_AFsessionwithQoS_create operation as will be discussed in further detail with respect to FIG. 5. In this case, the SMF-2 405 may map the PDU sessions for UE-1 401 and UE-2 402 and the QoS flows with the multimodal service flow session as configured by the AF 501. Once the PDU sessions and QoS flows are mapped with the multimodal service flow session, the SMF-1 404 may then extract the multimodal service flow configuration (e.g., at least the service correlation identifier and the one or more assistance parameters) and forward the multimodal service flow configuration to the AN node 403.

In some embodiments, SMF-2 405 checks that assistance parameters for UE-2 402 are aligned with the assistance parameters for other UEs corresponding to the same multimodality session, e.g., UE-1 401 prior to providing the assistance parameters to the AN node 403. In the instance the assistance parameters for UE-1 401 and UE-2 402 match, the SMF-2 405 may forward the assistance parameters to the AN node 403.

Once the AN node 403 receives the multimodal service flow configuration from SMF-2 405, AN node 403 may establish one or more DRBs with UE-2 402. The AN node 403 may also store the service correlation identifier and/or one or more assistance parameters in an associated memory.

FIG. 5 illustrates messages exchanged within a CN to configure one or more Qos streams for the one or more UEs with a multimodality session.

In operation 1 of FIG. 5, The AF 503 provides a QoS creation operation for one or more QoS streams of the PDU connection with network exposure function (NEF) 501. The QoS creation operation may be a nNef_AFsessionwithQoS_Create service operation. The AF 503 may provide the address of the one or more UEs associated with the PDU connection request as well as the service correlation identifier to the NEF 501.

In operation 2, the NEF 501 may authorize the AF 503 to request an apply policy to control the overall amount of pre-defined QoS authorized for the AF 503. In an instance the authorization is granted, the NEF 501 may provide a request to the policy charging function (PCF) 502 to derive the required QoS and to determine whether this QoS is allowed for UE-1 401. The request may be a Ncpcf_policy Authorization update request. The request may include the address of UE-1 401 and the service correlation identifier.

PCF 502 may determine whether the request is allowed and notify NEF 501 of whether the request is authorized. The NEF 501 may then send a response message to AF 503 indicating whether the request was authorized for UE-1 401. The response message may be a Nnef_AFsessionwithQoS_create response message.

In operation 3, in an instance the authorization is granted, the NEF 501 may provide a request to PCF 502 to derive the required QoS and to determine whether this QoS is allowed for UE-2 402. The request may be a Ncpcf_policy Authorization update request. The request may include the address of UE-1 402 and the service correlation identifier.

PCF 502 may determine whether the request is allowed and notify NEF 501 of whether the request is authorized. The NEF 501 may then send a response message to AF 503 indicating whether the request was authorized for UE-2 402. The response message may be a Nnef_AFsessionwithQoS_create response message.

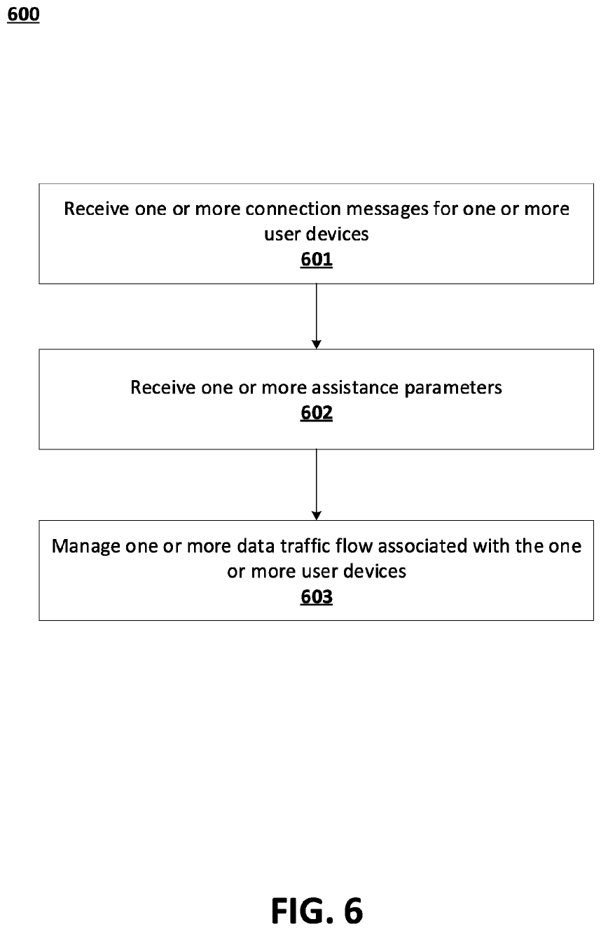

Referring now to FIG. 6, an example flowchart 600 is depicted that is implemented, for example, by an apparatus 300 embodied by a network entity, such as AN node 403, configured to manage data traffic related to a particular multimodal service flow.

As shown in block 601, the apparatus 300 embodied by a network entity, such as AN node 403, may include means, such as the processing circuitry 302, the communication interface 304 or the like, for receiving one or more connection messages for one or more UEs, such as UE-1 401 and/or UE-2 402. The one or more connection messages received may be part of a configuration of a multimodal service flow. The one or more connection messages may also include at least a service correlation identifier. The service correlation identifier may uniquely identify the multimodal service flow and correlate individual connection sessions from one or more user devices with one another. As such, connection messages corresponding to the same multimodal service flow may be identified using the service correlation identifier.

In some embodiments, the AN node 402 may map one or more QoS flows associated with the one or more UEs to one or more data radio bearers based at least in part on the received correlation identifier. In some embodiments, the one or more QoS flows may be mapped to one or more DRBs which correspond to a particular PDU session associated with the multimodal service flow. In some embodiments, one or more QoS flows within the same PDU session may correspond to different service correlation identifiers. Regardless of whether the QoS flows are mapped in aggregate or individually with a PDU session corresponding to a multimodal service flow, the AN node may be configured to enforce data traffic within the QoS flows based on a service correlation identifier and one or more associated assistance parameters as discussed in further detail below.

At block 602, the apparatus 300 embodied by a network entity, such as AN node 403, may include means, such as the processing circuitry 302, the communication interface 304 or the like, for receiving one or more assistances parameters which correspond to a particular service correlation identifier. The one or more assistance parameters may include one or more correlation assistance parameters. The one or more correlation assistance parameters may be indicative of at least one or more of an indication of which data traffic flows from the one or more UEs are correlated with one another, a priority class indicative of a relative priority ranking between the one or more correlated data traffic flows, which correlated data traffic flows are designated as mandatory, and which correlated data traffic flows are dependent data traffic flows. As such, the AN node 403 may be provided with an indication of how the individual data traffic flows within a particular multimodal service flow are related.

At block 603, the apparatus 300 embodied by a network entity, such as AN node 403, may include means, such as the processing circuitry 302, the communication interface 304 or the like, for managing one or more data traffic flows. The AN node 403 may manage the one or more data traffic flows based at least in part on the received service correlation identifier. In some embodiments, the AN node 403 may manage the one or more data traffic flows based at least in part on the associated correlation assistance parameters.

During management of data traffic flows, one or more interruption events may occur and the AN node 403 may be configured to use the one or more associated correlation assistance parameters for the particular service correlation identifier to manage the data traffic flow. For example, a data packet from a data stream may be dropped. In some embodiments, the AN node 403 may be configured to stop serving one or more correlated data traffic flows in an instance an interruption is detected that is associated with a mandatory data traffic flow as indicated by the one or more associated correlation assistance parameters. Alternatively, in some embodiments, the AN node 403 may be configured to update the relative priority class of the one or more correlated data traffic flows to the lowest priority in an instance an interruption is detected that is associated with a mandatory data traffic flow as indicated by the one or more associated correlation assistance parameters.

In some embodiments, the AN node 403 may allocate resources for the one or more data traffic flows based at least in part on the relative priority ranking between the one or more correlated data traffic flows. For example, one or more mandatory data traffic flows, as indicated by the one or more associated correlation assistance parameters, may be prioritized over other data traffic flows within the same multimodal service flow in an instance the communication network determines a need to deteriorate a QoS for one or more correlated data traffic flows. For instance, if the multimodal service flow is for a video call, data traffic streams corresponding to audio services, which may be assigned with a relative high level priority as compared to data traffic streams corresponding to video services, may be prioritized over the data traffic streams corresponding to video services. As such, video services may be disrupted but the higher priority audio services may continue to be un-disrupted.

In some embodiments, in an instance a network needs to temporarily disrupt one or more data traffic flow, such as during a handover procedure, the AN node 403 may be configured to interrupt the one or more data traffic flows as well as the one or more data traffic flows which are dependent upon the one or more data traffic flows as synchronously as possible.

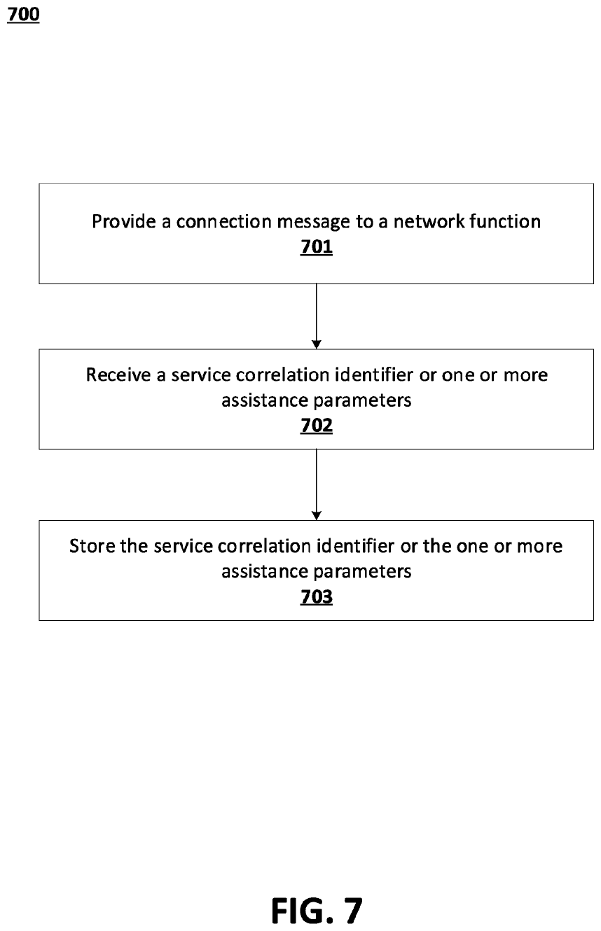

Referring now to FIG. 7, an example flowchart 700 is illustrated that is implemented, for example, by an apparatus 300 embodied by a UE, such as UE-1 401 and/or UE-2 402.

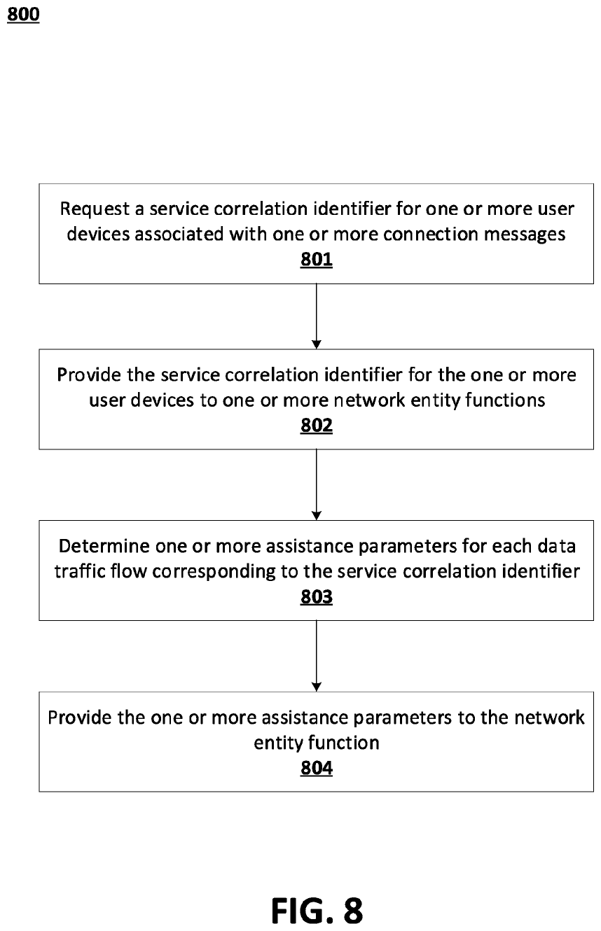

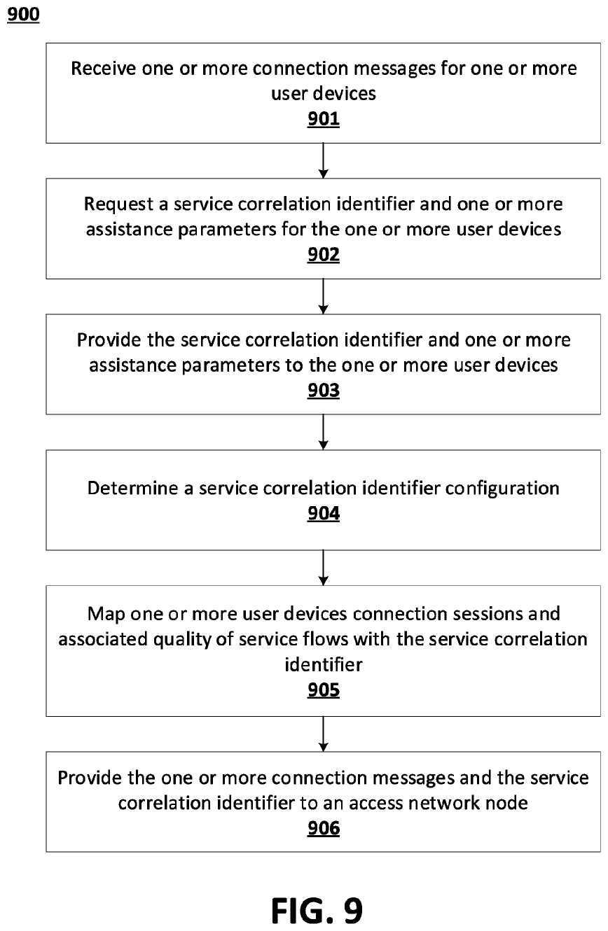

As shown in block 701, the apparatus 300 embodied by a UE, such as UE-1 401 or UE-2 402, may include means, such as the processing circuitry 302, the communication interface 304, memory 306 or the like, for providing a connection message to a network function. The connection message may be a packet data unit (PDU) procedure message, such as a PDU request and/or modification message. In some embodiments, the connection message is part of a configuration of multimodal service flow. In some embodiments, the connection message includes one or more assistance parameters and the one or more assistance parameters include at least a service correlation identifier. The service correlation identifier may uniquely identify the configuration of multimodal service flow such that the connection message may be associated with other connection messages corresponding to the same configuration of multimodal service flow. In some embodiments, the service correlation identifier and/or the one or more assistance parameters are preconfigured in an associated memory. In some embodiments, the UE-1 401 or UE-2 402 may not be preconfigured with the service correlation identifier and/or the one or more assistance parameters such that the one or more assistance parameters in the connection message may be empty and indicate a need to assign the UE-1 401 or UE-2 402 one or more assistance parameters and/or a service correlation identifier. This will be further discussed in FIGS. 8-9.

As shown in block 702, the apparatus 300 embodied by a UE, such as UE-1 401 or UE-2 402, may include means, such as the processing circuitry 302, the communication interface 304, or the like, for receiving a service correlation identifier or one or more assistance parameters. The service correlation identifier or one or more assistance parameters may be determined by an AF, such as AF 503.

As shown in block 703, the apparatus 300 embodied by a UE, such as UE-1 401 or UE-2 402, may include means, such as the processing circuitry 302, memory 306 or the like, for storing the service correlation identifier and/or the one or more assistance parameters in an associated memory. As such, the UE-1 401 or UE-2 402 may be configured with the service correlation identifier and/or one or more assistance parameters and may use these stored values in future connection messages.

Referring now to FIG. 8, an example flowchart 800 is presented that is implemented, for example, by an apparatus 300 embodied by a network entity, such as AF 503.

As shown in block 801, the apparatus 300 embodied by a network entity, such as AF 503, may include means, such as the processing circuitry 302, the communication interface 304, or the like, for requesting a service correlation identifier for the one or more UEs associated with one or more connection messages. In some embodiments, the AF 503 may request the service correlation identifier in an instance the connection message provided by a UE, such as UE-1 401 or UE-2 402 does not include a service correlation identifier value. The one or more connection messages may be part of a configuration of multimodal service flow. In some embodiments, the configuration of multimodal service flow may be indicated by a flag or any other suitable indication value such that a network function is aware the connection message is part of a configuration of multimodal service flow. The request for the service correlation identifier may include one or more UE addresses for the one or more UEs. The requested service correlation identifier may correlate individual connection sessions of the one or more devices with one another. The AF 503 may request the service correlation identifier as described in FIG. 5.

At block 802, the apparatus 300 embodied by a network entity, such as AF 503, may include means, such as the processing circuitry 302, the communication interface 304, or the like, for providing the service correlation identifier for the one or more UEs to one or more network entity functions. The one or more network entity functions may be an SMF, such as SMF-1 404 and/or SMF-2 405. In some embodiments, the one or more network entity functions may be the network entity functions serving the one or more UEs.

At block 803, the apparatus 300 embodied by a network entity, such as AF 503, may include means, such as the processing circuitry 302, the communication interface 304, or the like, for determining one or more assistance parameters for each data traffic flow corresponding to the service correlation identifier. The one or more assistance parameters may include at least one or more correlation assistance parameters which may be indicative of an indication of which data traffic flows from the one or more user devices are correlated with one another, a priority class indicative of a relative priority ranking between the one or more correlated data traffic flows, which correlated data traffic flows are designated as mandatory, and/or which correlated data traffic flows are dependent data traffic flows.

At block 804, the apparatus 300 embodied by a network entity, such as AF 503, may include means, such as the processing circuitry 302, the communication interface 304, or the like, for providing the one or more assistance parameters for the one or more UEs to one or more network entity functions. The one or more network entity functions may be an SMF, such as SMF-1 404 and/or SMF-2 405. In some embodiments, the one or more network entity functions may be the network entity functions serving the one or more UEs.

Referring now to FIG. 9, an example flowchart 800 is depicted that is implemented, for example, by an apparatus 300 embodied by a network entity, such as SMF-1 404 and/or SMF-2 405.

As shown in block 901, the apparatus 300 embodied by a network entity, such as SMF-1 404 and/or SMF-2 405, may include means, such as the processing circuitry 302, the communication interface 304, or the like, for receiving one or more connection messages for one or more user devices. The one or more connection messages for the one or more user devices may be part of a configuration of multimodal service flow. Each respective connection message may also include a session correlation identifier.

At block 902, the apparatus 300 embodied by a network entity, such as SMF-1 404 and/or SMF-2 405, may include means, such as the processing circuitry 302, the communication interface 304, or the like, for requesting a service correlation identifier and one or more assistance parameters for the one or more user devices. In some embodiments, the session correlation identifier value may be empty but a flag or any other suitable indication value may be included in the one or more connection messages indicating the one or more connection messages are part of a configuration of multimodal service flow. As such, the SMF-1 404 and/or SMF-2 405 may request a session correlation identifier and one or more assistance parameters be assigned to the one or more user devices. In some embodiments, SMF-1 404 and/or SMF-2 405 may request the session correlation identifier and one or more assistance parameters from AF 503.

At block 903, the apparatus 300 embodied by a network entity, such as SMF-1 404 and/or SMF-2 405, may include means, such as the processing circuitry 302, the communication interface 304, or the like, for providing the service correlation identifier and one or more assistance parameters to the one or more user devices, such as UE-1 401 and/or UE-2 402. As such, the one or more UEs may be provided with the service correlation identifier and one or more assistance parameters such that the one or more UEs may use the service correlation identifier and one or more assistance parameters in future connection messages.

At block 904, the apparatus 300 embodied by a network entity, such as SMF-1 404 and/or SMF-2 405, may include means, such as the processing circuitry 302, the communication interface 304, or the like, for determining a service identifier configuration. A service identifier configuration may include a service correlation identifier and the one or more assistance parameters. Thus, the service identifier configuration correlates the service correlation identifier with the one or more assistance parameters corresponding to a particular multimodal service flow.

In some embodiments, SMF-1 404 and/or SMF-2 405 may use the service correlation identifier to track UE events for the one or more UEs.

At block 905, the apparatus 300 embodied by a network entity, such as SMF-1 404 and/or SMF-2 405, may include means, such as the processing circuitry 302, the communication interface 304, or the like, for mapping one or more user device connection sessions and associated quality of service flows with the service correlation identifier.

At block 906, the apparatus 300 embodied by a network entity, such as SMF-1 404 and/or SMF-2 405, may include means, such as the processing circuitry 302, the communication interface 304, or the like, for providing the one or more connection messages and the service correlation identifier to an AN node, such as AN node 403. As such, the AN node 403 may establish one or more QoS flows, DRBs, and/or PDU sessions with the one or more UEs, such as UE-1 401 and/or UE-2 402 based at least in part on the service correlation identifier. In some embodiments, the service correlation identifier provided to the AN node 403 is provided for a respective connection session, such as a PDU session. In some embodiments, the service correlation identifier provided to the AN node 403 is provided for a respective QoS flow within a connection session.

In some embodiments, prior to providing the one or more connection messages and correlation identifier to the AN node 403, the SMF-1 404 and/or SMF-2 405 may be configured to determine whether the service correlation identifier for the respective connection message from one or more user devices are aligned. In an instance the service correlation identifier for each connection message from one or more user devices are aligned, SMF-1 404 and/or SMF-2 405 may provide the one or more connection messages to AN node 403.

FIGS. 4-9 illustrate message flows and flow charts depicting methods according to an example embodiment of the present invention. It will be understood that each block of the message flow may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 306 of an apparatus 300 employing an embodiment of the present invention and executed by a processing circuitry 302. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts and message flows support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Although a few variations have been described in detail above, other modifications or additions are possible. In particular, further features and/or variations may be provided in addition to those set forth herein. Moreover, the implementations described above may be directed to various combinations and sub-combinations of the disclosed features and/or combinations and sub-combinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

It should therefore again be emphasized that the various embodiments described herein are presented by way of illustrative example only and should not be construed as limiting the scope of the claims. For example, alternative embodiments can utilize different communication system configurations, user equipment configurations, base station configurations, identity request processes, messaging protocols and message formats than those described above in the context of the illustrative embodiments. These and numerous other alternative embodiments within the scope of the appended claims will be readily apparent to those skilled in the art.

1. An apparatus comprising:
at least one processor; and
at least one memory including computer program code,
the at least one memory and the computer program code configured to, with the at least one processor, cause the apparatus at least to:
receive connection messages for user devices, wherein (i) the connection messages for the user devices are received as part of configuring the apparatus for a multimodal service flow, and (ii) each connection message of the connection messages comprises a respective service correlation identifier; and
manage data traffic flows associated with the user devices based at least in part on the respective service correlation identifiers.

2. The apparatus of claim 1, wherein the at least one memory and the computer program code are further configured to, with the at least one processor, cause the apparatus at least to:
receive, one or more assistance parameters corresponding to each service correlation identifier, wherein the one or more assistance parameters corresponding to each service correlation identifier comprise one or more correlation assistance parameters, and wherein the one or more correlation assistance parameters comprise one or more of (i) an indication of which data traffic flows associated with the user devices are correlated with one another, (ii) a priority class indication indicative of a relative priority ranking between the data traffic flows that are correlated with one another, (iii) indication of which of the data traffic flows that are correlated with one another are designated as mandatory, or (iv) indication of which data traffic flows that are correlated with one another and are dependent data traffic flows.

3. The apparatus of claim 2, wherein the at least one memory and the computer program code are further configured to, with the at least one processor, cause the apparatus at least to:
in an instance of detection of an interruption associated with a mandatory data traffic flow, stop serving the one or more correlated data traffic flows.

4. The apparatus of claim 2, wherein the at least one memory and the computer program code are further configured to, with the at least one processor, cause the apparatus at least to:
in an instance of detection of an interruption associated with a mandatory data traffic flow, update the relative priority class of the one or more correlated data traffic flows to the lowest relative priority class.

5. The apparatus of claim 2, wherein the at least one memory and the computer program code are further configured to, with the at least one processor, cause the apparatus at least to:
allocate resources for the data traffic flows based at least in part on the relative priority ranking between the one or more correlated data traffic flows.

6. The apparatus of claim 2, wherein the at least one memory and the computer program code are further configured to, with the at least one processor, cause the apparatus at least to:
in an instance in which a handover procedure is required for at least one of the correlated data traffic flows, cause a handover of one or more additional correlated data traffic flows which are dependent on the data traffic flow for which the handover procedure is required.

7. The apparatus of claim 1, wherein the at least one memory and the computer program code are further configured to, with the at least one processor, cause the apparatus at least to:
map one or more quality of service flows associated with the one or more user devices to one or more data radio bearers based at least in part on the service correlation identifier.

8-28. (canceled)

29. An apparatus comprising:
at least one processor; and
at least one memory including computer program code,
the at least one memory and the computer program code configured to, with the at least one processor, cause the apparatus at least to:
send a request for a service correlation identifier for one or more user devices associated with one or more connection messages, wherein (i) the one or more connection messages associated with the one or more user devices are part of a configuration of multimodal service flow, (ii) the request for the service correlation identifier includes one or more user device addresses for the one or more user devices, and (iii) the service correlation identifier correlates individual connection sessions of the one or more user devices with one another; and
provide the service correlation identifier for the one or more user devices to one or more network entity functions.

30. The apparatus of claim 29, wherein the at least one memory and the computer program code are further configured to, with the at least one processor, cause the apparatus at least to:
determine one or more assistance parameters for each data traffic flow corresponding to the service correlation identifier; and
provide the one or more assistance parameters to the one or more network entity functions.

31. The apparatus of claim 29, wherein the one or more assistance parameters comprise one or more correlation assistance parameters, and wherein the one or more correlation assistance parameters comprise one or more of (i) an indication of which data traffic flows of the one or more data flows are correlated data flows, (ii) a priority class indication indicative of a relative priority ranking between the one or more correlated data traffic flows, (iii) an indication of which data traffic flows of the one or more data flows are correlated data traffic flows and designated as mandatory, or (iv) an indication of which data traffic flows of the one or more data flows are correlated data traffic flows and dependent data traffic flows, wherein the correlated data traffic flows comprise one of the one or more data traffic flows associated with the one or more user devices that are correlated with one another.

32-40. (canceled)

41. An apparatus comprising:
at least one processor; and
at least one memory including computer program code,
the at least one memory and the computer program code configured to, with the at least one processor, cause the apparatus at least to perform:
receive one or more connection messages for one or more user devices, wherein (i) the one or more connection messages for the one or more user devices are part of a configuration of a multimodal service flow, and (ii) respective connection messages of the one or more connection messages comprise a service correlation identifier; and
map connection sessions and associated quality of service flows of the one or more user devices with the service correlation identifier; and
provide the one or more connection messages for the one or more user devices to an access network node.

42. The apparatus of claim 41, wherein the at least one memory and the computer program code are further configured to, with the at least one processor, cause the apparatus at least to:
determine whether the service correlation identifier for the respective connection messages for respective user devices of the one or more user devices are aligned; and
in an instance the service correlation identifier for each respective connection message for the one or more user devices are aligned, provide the one or more connection messages to the access network node.

43. The apparatus of claim 41, wherein the at least one memory and the computer program code are further configured to, with the at least one processor, cause the apparatus at least to:
request the service correlation identifier and one or more assistance parameters for each respective user device of the one or more user devices; and
provide the service correlation identifier and one or more assistance parameters for the one or more user devices to the respective user device of the one or more user devices.

44. The apparatus of claim 41, wherein the at least one memory and the computer program code are further configured to, with the at least one processor, cause the apparatus at least to:
determine a service correlation identifier configuration, wherein the service correlation identifier configuration comprises at least (i) the service correlation identifier and (ii) the one or more assistance parameters.

45. The apparatus of claim 41, wherein the service correlation identifier is used to track user device events for the one or more user devices.

46. The apparatus of claim 41, wherein the service correlation identifier is provided to the access network node for a respective quality of service flow.

47-80. (canceled)
